(19) United States
(12) Patent Application Publication
(10) Pub. No.: US 2006/0132915 A1
(43) Pub. Date: Jun. 22, 2006

(54) Visual interfacing apparatus for providing mixed multiple stereo images

(76) Inventors: Ung Yeon Yang, Daejeon-city (KR); Dong Sik Jo, Busan-city (KR); Wook Ho Son, Daejeon-city (KR); Hyun Bin Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/223,066

(22) Filed: Sep. 8, 2005

(30) Foreign Application Priority Data
Dec. 16, 2004 (KR) 10-2004-0107221

(51) Int. Cl. G02B 27/22

(52) U.S. Cl. 359/463

(57) ABSTRACT

A visual interfacing apparatus for providing mixed multiple stereo images is provided. The visual interfacing apparatus includes: an external image processor receiving the actual image of the object and the external stereo images, dividing the received image into left/right viewing images, and outputting the left/right images; a viewing information extractor tracking a user's eye position, eye orientation, direction, and focal distance; an image creator creating predetermined 3D graphic stereo image information that is displayed to the user along with the images received by the external image processor as a mono image or a stereo image by left/right viewing, and outputting image information corresponding to each of the left/right viewing images according to the user's viewing information extracted by the viewing information extractor; and a stereo image processor combining the left/right image information received by the external image processor and the image creator based on the user's viewing information extracted by the viewing information extractor in 3D spatial coordinate space, and providing a user's view with combined multiple stereo images. Accordingly, the visual interfacing apparatus combines information of an external common stereo image apparatus and an internal personal stereo image apparatus, thereby overcoming a problem that a user can only use a single stereo image visualizing apparatus.

### BACKGROUND OF THE INVENTION

This application claims the benefit of Korean Patent Application No. 10-2004-0107221, filed on Dec. 16, 2004, in the Korean Intellectual Property Office, the disclosure of which is incorporated herein in its entirety by reference.

1. Field of the Invention

The present invention relates to virtual reality, and more particularly, to an interfacing apparatus for providing a user with mixed multiple stereo images.

2. Description of the Related Art

A virtual reality (VR) interface field uses stereo display technology that provides different image information for left and right viewings to create a computer stereo image. VR visual interfacing systems can be in the form of a wide screen based stereo visual systems for multiple users and portable stereo visual systems for personal users.

A wide screen based stereo visual system comprises a projection module that outputs a large scale image, a screen module that projects the image, and left and right viewing information separation modules that provide binocular viewing, e.g., a project attached polarizing filter, stereo glasses, etc., and allows multiple users to enjoy stereo image contents in a VR environment such as a theme park or a wide screen stereo movie theater.

A typical portable stereo visual system is a head or face mounted display (HMD/FMD) apparatus. The HMD/FMD apparatus, which is a combination of a micro display apparatus (e.g., small monitor, LCOS, etc.) and an optical enlargement structure similar to glasses, receives image information of separate modules for each eye and two channels for a stereo visual display. The HMD/FMD apparatus is used in environments in which private information is visualized or in situations whose a high degree of body freedom is required such as mobile computing.

Eye tracking technology that extracts user's viewing information is used to create an accurate stereo image. Pupil motion is tracked using computer vision technology or contact lens shaped tracking deuces are attached to corneas of eyes in order to track an object viewed by a user in an ergonomics evaluation test. These technologies enable eye direction to be tracked with precision of less than 1 degree.

A visual interfacing apparatus that visualizes stereo image contents is designed to be suitable for a limited environment. Therefore, the visual interfacing apparatus cannot visualize a variety of stereo image contents, and a large scale visualizing system can only provide information at the same viewpoint to each user.

In a virtual space cooperation environment, a stereo visual display apparatus that outputs a single stereo image cannot simultaneously use public information and private information. A hologram display apparatus which is regarded as an idealistic natural stereo image visual apparatus is just used for special effects in movies or manufactured as a prototype of laboratories, and is not a satisfactory solution.

Stereo image output technology has developed to generalize a stereo image display apparatus in the form of a stand-alone platform. In the near future, mobile/wearable computing technology will make it possible to generalize a personal VR interfacing apparatus and an interactive operation by mixing personal virtual information and public virtual information. Therefore, new technology is required to provide a user with two or more mixed stereo images.

### SUMMARY OF THE INVENTION

The present invention provides a visual interfacing apparatus for providing a user with two or more mixed stereo images.

According to an embodiment of the present invention, there is provided a visual interfacing apparatus for providing mixed multiple stereo images to display an image including an actual image of an object and a plurality of external stereo images created using a predetermined method, the visual interfacing apparatus comprising: an external image processor receiving the actual image of the object and the external stereo images, dividing the received image into left/right viewing images, and outputting the left/right images; a viewing information extractor tracking a user's eye position, eye orientation, direction, and focal distance; an image creator creating predetermined 3D graphic stereo image information that is displayed to the user along with the images received by the external image processor as a mono image or a stereo image by left/right viewing, and outputting image information corresponding to each of the left/right viewing images according to the user's viewing information extracted by the viewing information extractor; and a stereo image processor combining the left/right image information received by the external image processor and the image creator based on the user's viewing information extracted by the viewing information extractor in 3D spatial coordinate space, and providing a user's view with combined multiple stereo images.

The external image processor may comprise: a see-through structure, and transmits external light corresponding to the actual image and the stereo images of the object.

The external image processor may comprise a polarized filter that classifies the plurality of external stereo images into the left/right viewing images, or input a predetermined sync signal that generates the plurality of external stereo images and classifies the external stereo images into the left/right viewing information.

The viewing information extractor may comprise: a 6 degrees of freedom sensor that measures positions and inclinations of three-axes; and a user's eye tracking unit using computer vision technology.

The stereo image processor may use an Z-buffer(depth buffer) value to solve occlusion of the actual image of the object, the external stereo images, and multiple objects of the image information of the image creator. The image creator may comprise: a translucent reflecting mirror, reflects the image output by the image creator, transmits the image input by the external image processor, and displays combined multiple stereo images to the user's view.

The viewing information extractor may comprise: a sensor that senses user's motions including a user's head motion, and extracts viewing information including information on the user's head motion.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a visual interfacing apparatus for providing mixed multiple stereo images according to an embodiment of the present invention;

FIG. 2 is a diagram illustrating an environment to which the visual interfacing apparatus for providing mixed multiple stereo images according to an embodiment of the present invention is applied;

FIG. 3 illustrates a visual interfacing apparatus for providing mixed multiple stereo images according to an embodiment of the present invention;

FIG. 4 illustrates a visual interfacing apparatus for providing mixed multiple stereo images according to another embodiment of the present invention;

FIG. 5 is a photo of an environment to which a head mounted display (HMD) realized by a visual interfacing apparatus for providing mixed multiple stereo images according to an embodiment of the present invention is applied; and

FIG. 6 is an exemplary diagram of the HMD realized by a visual interfacing apparatus for providing mixed multiple stereo images.

### DETAILED DESCRIPTION OF THE INVENTION

The present invention will now be described more fully with reference to the accompanying drawings, in which exemplary embodiments of the invention are shown.

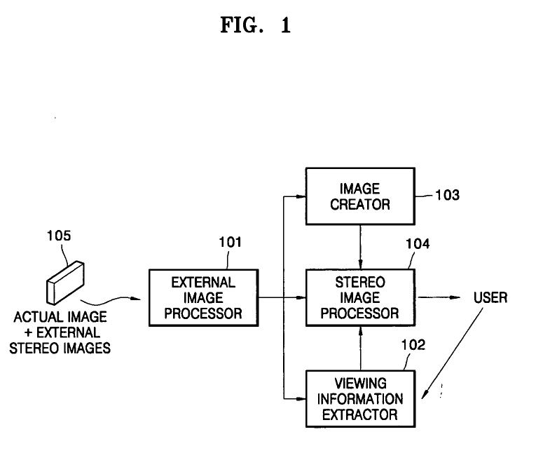

FIG. 1 is a block diagram of a visual interfacing apparatus for providing mixed multiple stereo images according to an embodiment of the present invention. The visual interfacing apparatus displays an image including an actual image of an object and a plurality of external stereo images created using a predetermined method for a user. Referring to FIG. 1, the visual interfacing apparatus comprises an external image processor 101 that receives an actual image of the object and the external stereo images, classifies the received images into left/right viewing information, and outputs classified images, a viewing information extractor 102 that extracts a user's eye position, orientation, direction and focal distance, an image creator 103 that creates a predetermined three-dimensional (3D) graphic stereo image to be displayed to the user along with the images received by the external image processor 101 as a mono image or a stereo image by left/right viewing, and outputs image information corresponding to left/right viewing images according to the user's viewing information extracted by the viewing information extractor 102, and a stereo image processor 104 that combines the left/right image information received by the external image processor 101 and the image creator 103 based on the user's viewing information extracted by the viewing information extractor 102 in 3D spatial coordinate space, and provides multiple stereo images for a user's view.

Each of the constituents will now be described in detail with reference to the following drawings.

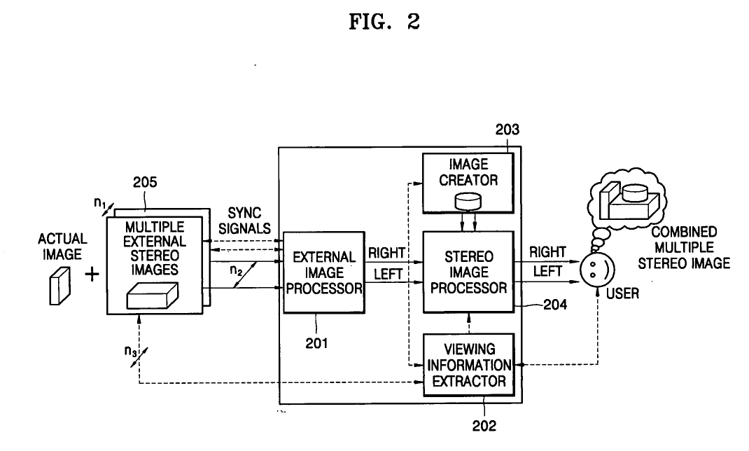

FIG. 2 is a diagram illustrating an environment to which the visual interfacing apparatus for providing mixed multiple stereo images according to an embodiment of the present invention is applied. Referring to FIG. 2, the visual interfacing apparatus combines an actual image and an image created by a multiple external stereo image apparatus 205 and an image creator 203 and displays the combined image to a user.

The user can see a natural combination, like a spatially virtual scene, of single or multiple external stereo images and information created from a personal stereo image apparatus of the present invention mounted by the user using the visual interfacing apparatus.

An external image processor 201 transmits an external actual image and an external stereo image via a see-through structure. The see-through structure uses an optical see-through method that transmits light outside as it is, and a video-based see-through method that transmits an external image obtained by a camera.

The external image processor 201 exchanges and uses sync signals for indicating an image received by external stereo image apparatuses and image apparatuses, if necessary (i.e., active synchronization stereo glasses), in order to classify n₂ multiple images created by the n₁ multiple external stereo image apparatuses 205 into left/right viewing information and receive the classified images.

For example, if an external stereo image apparatus is a monitor having a vertical frequency of 120 Hz, an image of 120 scanning lines is formed on the monitor. The external image processor 201 divides the image into a left image formed of odd scanning lines and a right image formed of even scanning lines, and receives the left/right images as the left/right viewing information. On the other hand, the external image processor 201 can divide the image into a left image formed of even scanning lines and a right image formed of odd scanning lines. The active synchronization stereo glasses which are connected to the monitor or a monitor mounted computer graphic card divide a stereo image displayed on the monitor into the left/right viewing information according to a sync signal which is the vertical frequency of the monitor.

On the other hand, user's glasses to which the present invention is applied can alternatively open and close left and right lenses in synchronization with the odd scanning lines and even scanning lines, respectively, and receive the left/right viewing information.

For another example, if 120 images per second are displayed on the monitor, the external image processor 201 divides the odd 60 images into left images and the even 60 images into right images, and receives the left/right images as the left/right viewing information. And user's glasses to which the present invention is applied can alternatively open and close left and right lenses in synchronization with the odd images and even images, respectively, and receive the left/right viewing information.

There are various methods of dividing the left/right viewing information to provide users with a stereo image besides the methods mentioned above. Such methods can easily be selected by one of ordinary skill in the art and is applied to the present invention, and thus their descriptions are omitted.

The external image processor 201 can use a fixed apparatus in order to classify n₂ multiple images created by the n₁ multiple external stereo image apparatuses 205 into left/right viewing information and receive the classified images. For example, the visual interfacing apparatus is realized as glasses, the external image processor 201 can be realized as a polarized filter that is mounted on lenses of passive synchronization stereo glasses. The polarized filter can correspond to or be compatible with the multiple external stereo image apparatuses n₁ 205.

The input multiple images are classified into the left/right viewing information via the external image processor 201 and transferred to a stereo image processor 204.

The image creator 203 creates 3D graphic stereo image information related to a personal user as a mono image or a stereo image by left/right viewing, and transfers image information corresponding to each of the right/left viewing images to the stereo image processor 204. If an actual image and multiple external stereo images are background images, the image created by the image creator 203 has the actual image and multiple external stereo images as the background images. Such an image will be described in detail.

A viewing information extractor 202 tracks a user's eye position, orientation, direction, focal distance to create an accurate virtual stereo image.

To this end, the viewing information extractor 202 comprises a 6 degrees of freedom sensor that measures positions and inclinations of three axes, and a user's eye tracking unit using computer vision technology. There are various methods of tracking a head and eyes using the sensor and computer vision technology, which are obvious to those of ordinary skill in the art and which can be applied to the present invention, and thus their descriptions are omitted.

The viewing information extracted by the viewing information extractor 202 is transferred (n₃) to the image creator 203 and the stereo image processor 204 via a predetermined communication module. The image creator 203 uses the viewing information extracted by the viewing information extractor 202 when creating the image corresponding to the left/right viewing information.

The viewing information extracted by the viewing information extractor 202 is transferred to the multiple external stereo image apparatuses 205 and used to create or display a stereo image. For example, if user's eyes move to a different direction, a screen corresponding to the direction of the user's eyes is displayed and not a current screen

The stereo image processor 204 combines the left/right image information input by the external image processor 201 and the image creator 203 on a 3D space coordinate based on the viewing information extracted by the viewing information extractor 202. In this operation, multiple objects which simultaneously appear can be occluded. The stereo image processor 204 uses an Z-buffer(depth buffer) value to solve occlusion in multiple objects.

There are various 3D image creating methods related to image combination or 3D computer graphics, and one of the methods can be easily selected by one of ordinary skill in the art.

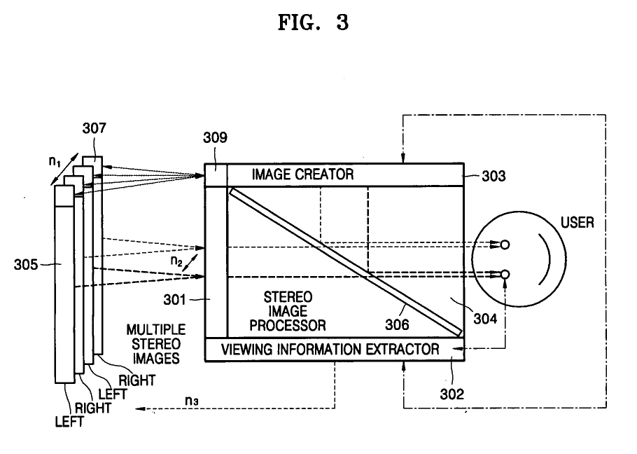

FIG. 3 illustrates a visual interfacing apparatus for providing mixed multiple stereo images according to an embodiment of the present invention. The visual interfacing apparatus is used to process an optical see-through stereo image.

An external image processor 301 filters n₁ multiple stereo images 307 received by n₁ multiple external stereo image apparatuses 305 and transfers the filtered image to a stereo image processor 304.

The image from the external image processor 301 is combined with image information of an image creator 303 in a translucent reflecting mirror 306 and is then viewed by a user. The image input from the external image processor 301 transmits the translucent reflecting mirror 306 and the image output by the image creator 303 is reflected in the translucent reflecting mirror 306 and is transferred to the user's viewing. Such an optical image combination operation or augmented reality is widely known, and thus its description is omitted.

Since the optical image combination operation is required to design the visual interfacing apparatus, the multiple external stereo image apparatuses 305 and the image creator 303 control a virtual camera that renders virtual contents using the user's eye information (eye position, eye direction, focal distance, etc.) extracted by a viewing information extractor 302, thereby making multiple image matching easy.

An active stereo image synchronization processor 309 is connected to the n₁ multiple external stereo image apparatuses 305, actively synchronizes images, and assists the external image processor 301 in dividing left/right images and transferring the divided images.

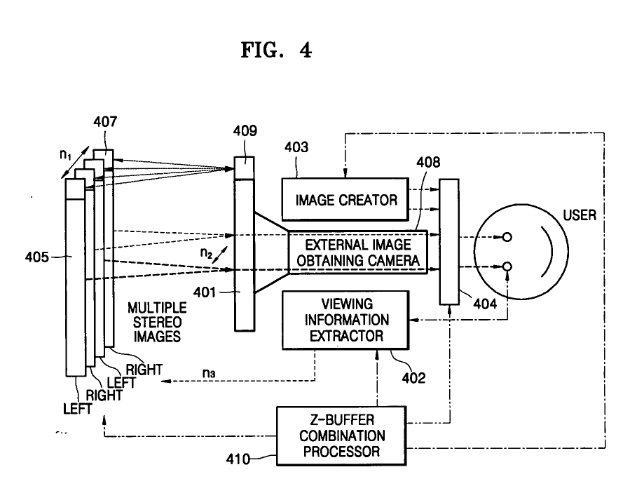

FIG. 4 illustrates a visual interfacing apparatus for providing mixed multiple stereo images according to another embodiment of the present invention. The visual interfacing apparatus has a video-based see-through stereo image processing structure.

An external image processor 401 selects and obtains external stereo images as left/right images using a filter and an external image obtaining camera 408 and transfers the obtained left/right images. The external stereo images are transmitted to a stereo image processor 404 to transform the images into 3D image information using a computer image processing method. There are various image processing methods, computer vision methods, and/or augmented reality methods using the camera, and thus one of the methods can be easily selected by one of ordinary skill in the art.

An image creator 403 creates an image suitable for left/right viewing based on viewing information extracted by a viewing information extractor 402. The stereo image processor 404 z-buffers(depth buffers) external stereo image information and far end stereo image information provided by the image creator 403 and combines them into a stereo image space.

To accurately combine multiple stereo image information, occlusion of multiple virtual objects is solved based on information transferred by a z-buffer(depth buffer) information combination processor 410 that combines z-buffers(depth buffers) of external multiple stereo images.

Similar to the active stereo image synchronization processor 309 illustrated in FIG. 3, an active stereo image synchronization processor 409 is connected to the multiple external stereo image apparatuses n₁ 405, actively synchronizes images, and assists the external image processor 401 in dividing left/right images and transferring the divided images.

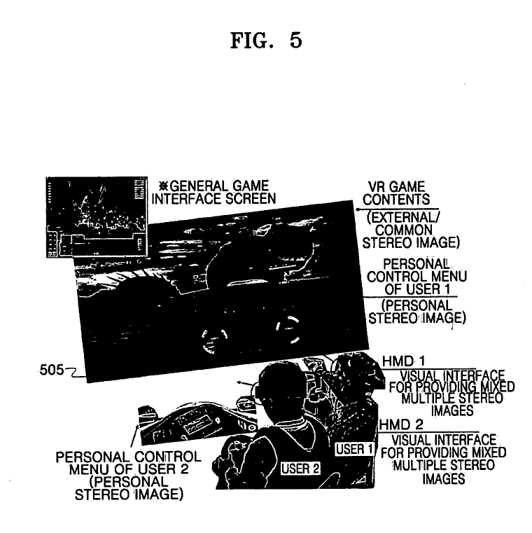

FIG. 5 is a photo of an environment to which a HMD realized by a visual interfacing apparatus for providing mixed multiple stereo images according to an embodiment of the present invention is applied. The visual interfacing apparatus is realized as the HMD and is used for VR games for multiple users.

An external game space 505 displays the VR game contents and is an external stereo image provided to all of the users. The image is visualized in a wide stereo image display system such as a projection system and can be simultaneously observed by users 1 and 2 who play the VR game.

For example, HMD 1, that is mounted by user 1 who plays a hunter, visualizes an image in combination with stereo image information (e.g., a sighting board, a dashboard) for controlling arms and external image information. HMD 2 that is mounted by user 2 who plays a driver, visualizes an image in combination with stereo image information (e.g., a dashboard for a driver's seat) for driving a car and external image information.

Users 1 and 2 cannot see each other's personal information (i.e., images created by each of image creators of HMDs 1 and 2). A third person (e.g., a spectator) who joins the VR game can see results of the VR game from users'actions (e.g., changes in driving direction, arms launch). Information unrelated to users is visualized on a common screen such as the usual multiple participating game interface screen illustrated in FIG. 5 to prevent visibility confusion. That is, images provided by each of the image creators of HMDs 1 and 2 are users' own images.

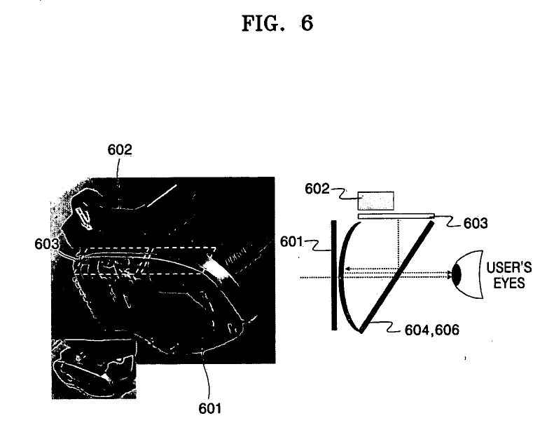

FIG. 6 is an exemplary diagram of the HMD realized by a visual interfacing apparatus for providing mixed multiple stereo images in which a photo of a prototype of the visual interfacing apparatus for providing mixed optical see-through multiple stereo images and its structural diagram are included.

An external image processor 601 includes a polarized film that selects external stereo images and transmits the selected image. Similar to the stereo image processor 304 illustrated in FIG. 3, a stereo image processor 604 includes a translucent reflecting mirror 606, combines external images input via the polarized film and images created by an image creator 603, and displays the combined image.

A viewing information extractor 602 includes a sensor that senses user's motions including a head motion and extracts viewing information including information on the user's head motion.

A user can simultaneously see a stereo image related to his own interface and a stereo image of external contents using the optical see-through HMD apparatus similar to the embodiment of FIG. 5.

It can be understood by those of ordinary skill in the art that each of the operations performed by the present invention can be realized by software or hardware using general programming methods.

The visual interfacing apparatus for providing mixed multiple stereo images comprises an external image processor receiving the actual image of the object and the external stereo images, dividing the received image into left/right viewing images, and outputting the left/right images; a viewing information extractor tracking a user's eye position, eye orientation, direction, and focal distance; an image creator creating predetermined 3D graphic stereo image information that is displayed to the user along with the images received by the external image processor as a mono image or a stereo image by left/right viewing, and outputting image information corresponding to each of the left/right viewing images according to the user's viewing information extracted by the viewing information extractor; and a stereo image processor combining the left/right image information received by the external image processor and the image creator based on the user's viewing information extracted by the viewing information extractor in 3D spatial coordinate space, and providing a user's view with combined multiple stereo images. Accordingly, the visual interfacing apparatus for providing mixed multiple stereo images of the present invention combines information of an external common stereo image apparatus and an internal personal stereo image apparatus, thereby overcoming a conventional defect that a user can only use a single stereo image visualizing apparatus. Using mobile computing or augmented reality based cooperation, the visual interfacing apparatus for providing mixed multiple stereo images of the present invention combines externally visualized stereo image information and a personal stereo image via a portable stereo visual interface, thereby assisting the user in controlling various stereo images. Therefore, multiple-player VR games can be realized in an entertainment field, and training systems for virtual engineering, wearable computing, and ubiquitous computing can have wide ranges of applications in a VR environment.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A visual interfacing apparatus for providing mixed multiple stereo images to display an image including an actual image of an object and a plurality of external stereo images created using a predetermined method, the visual interfacing apparatus comprising:
an external image processor receiving the actual image of the object and the external stereo images, dividing the received image into left/right viewing images, and outputting the left/right images;
a viewing information extractor tracking a user's eye position, eye orientation, direction, and focal distance;
an image creator creating predetermined 3D graphic stereo image information that is displayed to the user along with the images received by the external image processor as a mono image or a stereo image by left/right viewing, and outputting image information corresponding to each of the left/right viewing images according to the user's viewing information extracted by the viewing information extractor; and
a stereo image processor combining the left/right image information received by the external image processor and the image creator based on the user's viewing information extracted by the viewing information extractor in 3D spatial coordinate space, and providing a user's view with combined multiple stereo images.

2. The visual interfacing apparatus of claim 1, wherein the external image processor comprise: a see-through structure, and transmits external light corresponding to the actual image and the stereo images of the object.

3. The visual interfacing apparatus of claim 1, wherein the external image processor obtains the actual image and the stereo images of the object using a camera.

4. The visual interfacing apparatus of claim 1, wherein the external image processor comprises a polarized filter that classifies the plurality of external stereo images into the left/right viewing images.

5. The visual interfacing apparatus of claim 1, wherein the external image processor inputs a predetermined sync signal that generates the plurality of external stereo images and classifies the external stereo images into the left/right viewing information.

6. The visual interfacing apparatus of claim 1, wherein the viewing information extractor comprises:
a 6 degrees of freedom sensor that measures positions and inclinations of three-axes; and
a user's eye tracking unit using computer vision technology.

7. The visual interfacing apparatus of claim 1, wherein the stereo image processor uses an Z-buffer(depth buffer) value to solve occlusion of the actual image of the object, the external stereo images, and multiple objects of the image information of the image creator.

8. The visual interfacing apparatus of claim 1, wherein the image creator comprises: a translucent reflecting mirror, reflects the image output by the image creator, transmits the image input by the external image processor, and displays combined multiple stereo images to the user's view.

9. The visual interfacing apparatus of claim 3, wherein the stereo image processor comprises: a translucent reflecting mirror, reflects the image output by the image creator, transmits the image input from the external image processor, or transmits the image obtained by the camera, and displays combined multiple stereo images to the user's view.

10. The visual interfacing apparatus of claim 1, wherein the viewing information extractor comprises: a sensor that senses user's motions including a user's head motion, and extracts viewing information including information on the user's head motion.
